(19) United States
(12) Patent Application Publication
(10) Pub. No.: US 2019/0071094 A1
(43) Pub. Date: Mar. 7, 2019

(54) VEHICLE CONTROL SYSTEM, VEHICLE CONTROL METHOD, AND STORAGE MEDIUM

(71) Applicant: HONDA MOTOR CO., LTD., Tokyo (JP)

(72) Inventors: Haruhiko Nishiguchi, Wako-shi (JP); Yoshifumi Banno, Wako-shi (JP); Hiroyuki Koibuchi, Wako-shi (JP)

(21) Appl. No.: 16/109,859

(22) Filed: Aug. 23, 2018

(30) Foreign Application Priority Data
Sep. 1, 2017 (JP) 2017-168973

(51) Int. Cl. B60W 30/18; G05D 1/02

(52) U.S. Cl. CPC B60W 30/18163; B62D 15/0255; B60W 2550/20; G05D 1/021

(57) ABSTRACT

A vehicle control system includes a detection unit which detects the position of a lane marker on a road surface in a traveling direction of a vehicle, a storage unit which stores the position of the lane marker detected by the detection unit in a predetermined range in the traveling direction and a lane change control unit which controls lane change of the vehicle on the basis of the position of the lane marker detected by the detection unit, wherein the lane change control unit determines whether lane change is possible on the basis of the position of the lane marker in the predetermined range stored in the storage unit in a case that the lane marker is not detected by the detection unit and controls lane change of the vehicle on the basis of the position of the lane marker in the predetermined range in a case that it is determined that lane change is possible.

### CROSS-REFERENCE TO RELATED APPLICATION

Priority is claimed on Japanese Patent Application No. 2017-168973, filed Sep. 1, 2017, the content of which is incorporated herein by reference.

### BACKGROUND OF THE INVENTION

### Field of the Invention

The present invention relates to a vehicle control system, a vehicle control method, and a storage medium.

### Description of Related Art

A driving assistance apparatus by which a vehicle traveling on a road having a plurality of lanes automatically changes lanes is known (for example, Japanese Unexamined Patent Application, First Publication No. 2014-133477). This driving assistance apparatus recognizes lanes from a captured front view image of a host vehicle, sets a target trajectory and causes the vehicle to travel along the target runway.

### SUMMARY OF THE INVENTION

However, in a case that lanes are not recognized during automatic lane change, the aforementioned conventional technology cannot cope with control of lane change according to various road alignments appearing thereafter.

An object of embodiments of the present invention devised in view of the aforementioned circumstances is to provide a vehicle control system, a vehicle control method and a storage medium capable of, even in a case that lanes are difficult to recognize during automatically performed lane change, ending lane change on the basis of data of lanes recorded until immediately before lane change.

A vehicle control system, a vehicle control method and a storage medium according to the present invention employ the following configurations.

(1): A vehicle control system according to one aspect of the present invention includes: a detection unit which detects a position of a lane marker on a road surface in a traveling direction of a vehicle; a storage unit which stores the position of the lane marker detected by the detection unit in a predetermined range in the traveling direction; and a lane change control unit which controls lane change of the vehicle on the basis of the position of the lane marker detected by the detection unit, wherein the lane change control unit determines whether lane change is possible on the basis of the position of the lane marker in the predetermined range stored in the storage unit in a case that the position of the lane marker is not detected by the detection unit and controls lane change of the vehicle on the basis of the position of the lane marker in the predetermined range stored in the storage unit in a case that it is determined that lane change is possible.

(2): In the aspect of (1), the lane change control unit determines whether lane change can be ended on the basis of the position of the lane marker in the predetermined range stored in the storage unit in a case that the position of the lane marker is not detected by the detection unit during a period from start to end of lane change and, in a case that it is determined that lane change cannot be ended, causes the vehicle to travel in a direction in which an angle between an extending direction of the lane marker in the predetermined range stored in the storage unit and a yaw angle of the vehicle decreases.

(3): In the aspect of (2), the detection unit further detects a position of another vehicle traveling in front of the vehicle, and the lane change control unit determines whether lane change can be ended on the basis of the position of the lane marker in the predetermined range stored in the storage unit in a case that the position of the lane marker is not detected by the detection unit during a period from start to end of lane change and, in a case that it is determined that lane change cannot be ended, causes the vehicle to travel following the other vehicle.

(4): In the aspect of (3), the lane change control unit determines whether lane change can be ended on the basis of the position of the lane marker in the predetermined range stored in the storage unit in a case that the position of the lane marker is not detected by the detection unit during the period from start to end of lane change and, in a case that it is determined that lane change cannot be ended, causes the vehicle to travel following another vehicle traveling in a lane which is a lane change destination.

(5): In the aspect of (4), the lane change control unit determines whether lane change can be ended on the basis of the position of the lane marker in the predetermined range stored in the storage unit in a case that the position of the lane marker is not detected by the detection unit during the period from start to end of lane change and, in a case that it is determined that lane change cannot be ended and there are no other vehicles traveling in the lane which is the lane change destination, causes the vehicle to travel following another vehicle traveling in a lane which is a lane change origin.

(6): A vehicle control method according to one aspect of the present invention is executed by a computer mounted in a vehicle, wherein the computer: detects a position of a lane marker on a road surface in a traveling direction of a vehicle; stores the detected position of the lane marker in a predetermined range in the traveling direction in a storage unit; controls lane change of the vehicle on the basis of the detected position of the lane marker; determines whether lane change is possible on the basis of the position of the lane marker in the predetermined range stored in the storage unit in a case that the lane marker is not detected; and controls lane change of the vehicle on the basis of the position of the lane marker in the predetermined range in a case that it is determined that lane change is possible.

(7): A storage medium according to one aspect of the present invention is a computer readable non-transitory storage medium storing a program which causes a computer: to detect a position of a lane marker on a road surface in a traveling direction of a vehicle; to store the detected position of the lane marker in a predetermined range in the traveling direction in a storage unit; to control lane change of the vehicle on the basis of the detected position of the lane marker and determine whether lane change is possible on the basis of the position of the lane marker in the predetermined range stored in the storage unit in a case that the lane marker is not detected; and to control lane change of the vehicle on the basis of the position of the lane marker in the predetermined range in a case that it is determined that lane change is possible.

According to the aspects of (1), (6) and (7), it is possible to, even in a case that lanes are difficult to recognize during automatically performed lane change, end lane change on the basis of data of lanes recorded until immediately before lane change.

According to (2), it is possible to control a vehicle until lane change is ended on the basis of data of lanes recorded until immediately before lane change even in a situation in which lane change cannot be ended.

According to (3), (4) and (5), it is possible to end lane change without deviating from a lane by performing control of following a preceding vehicle on the basis of data of lanes recorded until immediately before lane change even in a situation in which lane change cannot be ended.

### BRIEF DESCRIPTION OF THE DRAWINGS

FIG. 1 is a block diagram of a vehicle control system of a first embodiment.

FIG. 2 is a diagram showing a state in which a relative position and an attitude of a host vehicle with respect to a lane are recognized by a host vehicle position recognition unit.

FIG. 3 is a diagram showing details of a process performed by a lane change assistance control unit.

FIG. 4 is a diagram showing an example of a state in which there is a non-detection section in which a lane marker is difficult to see during lane change assistance control.

FIG. 5 is a diagram describing an example of lane change assistance control in a case that a second distance is shorter than a first distance.

FIG. 6 is a flowchart showing an example of a process flow of the vehicle control system.

FIG. 7 is a diagram showing an example of a configuration of a vehicle control system of a second embodiment.

FIG. 8 is a diagram showing an example of a state in which there is a non-detection section P in which a lane marker is difficult to see during lane change assistance control.

FIG. 9 is a flowchart showing an example of a process flow of the vehicle control system.

FIG. 10 is a diagram showing an example of a configuration in which the vehicle control system is applied to an autonomous drive vehicle 500.

FIG. 11 is a diagram showing a plurality of configurations which may be used in driving assistance control units 100 and 200A.

### DETAILED DESCRIPTION OF THE INVENTION

Hereinafter, embodiments of a vehicle control system, a vehicle control method and a storage medium of the present invention will be described with reference to the drawings.

### FIRST EMBODIMENT

### Overall Configuration

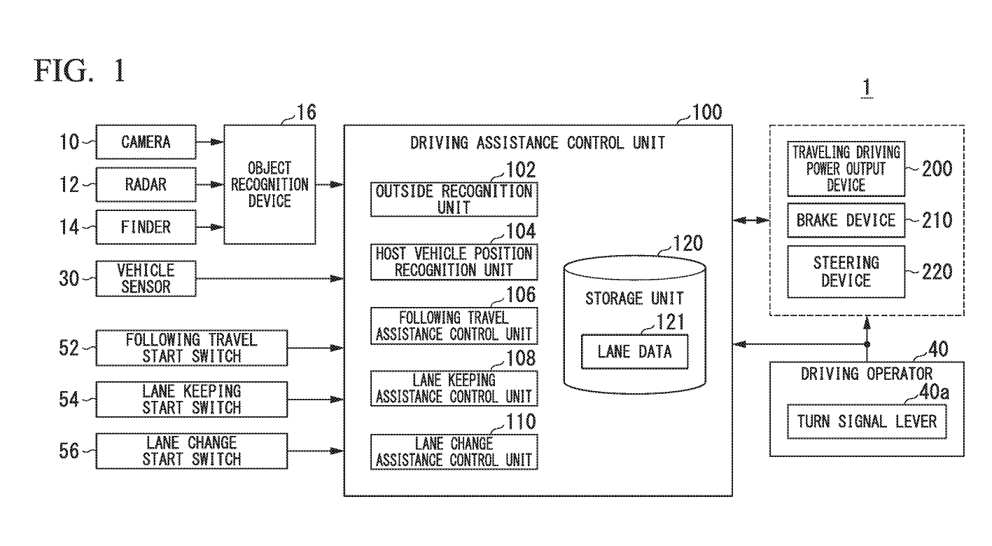

FIG. 1 is a block diagram of a vehicle control system 1 of a first embodiment. For example, a vehicle (hereinafter referred to as a host vehicle M) in which the vehicle control system 1 is mounted is a two-wheeled vehicle, a three-wheeled vehicle, a four-wheeled vehicle or the like and a driving source thereof is an internal combustion engine such as a diesel engine or a gasoline engine, a motor or a combination thereof. A motor operates using power generated by a generator connected to an internal combustion engine or discharged power of a secondary battery or a fuel cell.

For example, the vehicle control system 1 includes a camera 10, a radar 12, a finder 14, an object recognition device 16, a vehicle sensor 30, a driving operator 40, a following travel start switch 52, a lane keeping start switch 54, a lane change start switch 56, a driving assistance control unit 100, a traveling driving power output device 200, a brake device 210, and a steering device 220. These devices and apparatuses are connected through a multi-communication line such as a controller area network (CAN) communication line, a serial communication line, a wireless communication network or the like. The configuration shown in FIG. 1 is an example and some of the components may be omitted or other components may be added.

For example, the camera 10 is a digital camera using a solid-state image sensing device such as a charge coupled device (CCD) and a complementary metal oxide semiconductor (CMOS). One or more cameras 10 are attached to any points on the host vehicle M. In a case that a front view image is captured, the camera 10 is attached to the upper part of the front windshield, the back side of a rear-view mirror, or the like. For example, the camera 10 periodically repeatedly photographs the surroundings of the host vehicle M. The camera 10 may be a stereo camera.

The radar 12 radiates radio waves such as millimeter waves to the surroundings of the host vehicle M and detects radio waves (reflected waves) reflected by an object to detect at least the position of (distance and direction to) the object. One or more radars 12 are attached to any points on the host vehicle M. The radar 12 may detect the position and speed of an object through a frequency modulated continuous wave (FM-CW) method.

The finder 14 is light detection and ranging or laser imaging detection and ranging (LIDAR) finder for measuring scattered light with respect to radiated light to detect a distance to a target. One or more finders 14 are attached to any points on the host vehicle M.

The object recognition device 16 performs sensor fusion processing on detection results of some or all of the camera 10, the radar 12 and the finder 14 to recognize positions, types, speeds, movement directions and the like of objects. For example, the recognized objects may be types of object such as a vehicle, a guard rail, an electricity pole, a pedestrian and a traffic sign. The object recognition device 16 outputs recognition results to the driving assistance control unit 100. The object recognition device 16 may output some of information input from the camera 10, the radar 12 or the finder 14 to the driving assistance control unit 100 as it is.

For example, the vehicle sensor 30 includes a vehicle speed sensor for detecting the speed of the host vehicle M, an acceleration sensor for detecting an acceleration, a yaw rate sensor for detecting an angular velocity around a vertical axis, a direction sensor for detecting a direction of the host vehicle M, and the like. Each sensor included in the vehicle sensor 30 outputs a detection signal indicating a detection result to the driving assistance control unit 100.

The driving operator 40 includes various operators such as the aforementioned steering wheel, a turn signal lever 40a for operating a turn signal (direction indicator), an accelerator pedal, a brake pedal and a shift lever, for example. For example, an operation detection unit for detecting an operation quantity of an operation of an occupant is attached to each operator of the driving operator 40. For example, the operation detection unit detects a position of the turn signal lever 40a, depression amounts of the accelerator pedal and the brake pedal, a position of the shift lever, a steering angle, a steering torque and the like of the steering wheel. In addition, the operation detection unit outputs a detection signal indicating a detection result to one or both of the driving assistance control unit 100, and the traveling driving power output device 200 and a combination of the brake device 210 and the steering device 220.

The following travel start switch 52 is a switch for starting following travel assistance control according to an operation of the occupant. The lane keeping start switch 54 is a switch for starting lane keeping assistance control according to an operation of the occupant. The lane change start switch 56 is a switch for starting lane change assistance control according to an operation of the occupant.

Prior to description of the driving assistance control unit 100, the traveling driving power output device 200, the brake device 210 and the steering device 220 will be described. The traveling driving power output device 200 outputs traveling driving power (torque) for traveling of the host vehicle M to driving wheels. For example, the traveling driving power output device 200 includes a combination of an internal combustion engine, a motor, a transmission and the like and a power electronic control unit (ECU) for controlling the combination. The power ECU controls the aforementioned components according to information input from the driving assistance control unit 100 or information input from the driving operator 40.

The brake device 210 includes a brake caliper, a cylinder which transfers hydraulic pressure to the brake caliper, an electric motor which generates hydraulic pressure in the cylinder, and a brake ECU, for example. The brake ECU controls the electric motor according to information input from the driving assistance control unit 100 or information input from the driving operator 40 such that a brake torque according to a braking operation is output to each wheel. The brake device 210 may include a mechanism for transferring hydraulic pressure generated according to operation of the brake pedal included in the driving operator 40 to the cylinder through a master cylinder as a backup. The brake device 210 is not limited to the aforementioned configuration and may be an electronically controlled hydraulic brake device which controls an actuator according to information input from the driving assistance control unit 100 to transfer hydraulic pressure of a master cylinder to a cylinder.

The steering device 220 includes a steering ECU and an electric motor, for example. The electric motor applies a force acting on a rack and piston mechanism to change a steering direction of the wheels, for example. The steering ECU drives the electric motor according to information input from the driving assistance control unit 100 or information input from the driving operator 40 to change the steering direction of the wheels.

### Configuration of Driving Assistance Control Unit

For example, the driving assistance control unit 100 includes an outside recognition unit 102, a host vehicle position recognition unit 104, a following travel assistance control unit 106, a lane keeping assistance control unit 108, a lane change assistance control unit 110, and a storage unit 120. A combination of the outside recognition unit 102 and the host vehicle position recognition unit 104 is an example of a “detection unit.” A combination of the lane change assistance control unit 110 and the following travel assistance control unit 106 is an example of a “lane change control unit.”

Such constituent elements of the driving assistance control unit 100 may be realized by a hardware processor such as a central processing unit (CPU) executing a program (software), for example. Part or all of these constituent elements may be realized by hardware (circuit unit including circuitry) such as a large scale integration (LSI), an application specific integrated circuit (ASIC) and a field-programmable gate array (FPGA) and a graphic processing unit (GPU) or may be realized by cooperation of software and hardware. For example, the program may be stored in advance in a storage device (not shown) such as a hard disk drive (HDD) and a flash memory included in the master control unit 100 or may be stored in a detachable storage medium such as a DVD or a CD-ROM and installed in the storage device by mounting the storage medium in a drive device.

The storage unit 120 is realized by a hard disk drive (HDD), a flash memory, a random access memory (RAM), a read only memory (ROM) or the like.

The outside recognition unit 102 recognizes positions of neighboring vehicles and states thereof such as speeds, accelerations and the like on the basis of information input from the camera 10, the radar 12 and the finder 14 through the object recognition device 16. The position of a neighboring vehicle may be represented by a representative point such as the center of gravity or a corner of the neighboring vehicle or represented by a region expressed by the contour of the neighboring vehicle. “States” of a neighboring vehicle may include the acceleration and jerk of the neighboring vehicle or an “action state” (e.g., whether the neighboring vehicle is changing lanes or intends to change lanes). The outside recognition unit 102 may recognize states of other types of object such as a guard rail, an electricity pole, a parked vehicle and a pedestrian in addition to neighboring vehicles.

The outside recognition unit 102 recognizes a plurality of lanes Lm (m=1, 2, 3, . . . ) on a road R on which the host vehicle M is traveling on the basis of an image captured by the camera 10. The outside recognition unit 102 recognizes lane markers LMm of the surface of the road R in recognition of lanes. For example, the lane markers LMm include a pole, Bott's dots, a chatter bar, a cat's eye, a guard rail, a median strip, a color-coded lane and the like in addition to a white line and a yellow line drawn on roads to distinguish between lanes on roads. The outside recognition unit 102 recognizes lane markers LMm on the road R on the basis of recognized lane markers LMm. The outside recognition unit 102 recognizes a plurality of lanes Lm on the basis of the recognized lane markers LMm.

The outside recognition unit 102 stores the positions of lane markers LMm which are recognized in a predetermined range, in a traveling direction of the host vehicle M on the basis of an image captured by the camera 10, in the storage unit 120 as lane data 121. The predetermined range includes the concept of a distance or time. For example, the outside recognition unit 102 may convert the positions of lane markers LMm corresponding to a predetermined distance in the traveling direction of the host vehicle M into data represented as relative coordinates with respect to the host vehicle M on a two-dimensional plane on the basis of the image captured by the camera 10 to generate the lane data 121.

For example, the position of a lane marker LMm may be generated as a position on a relative plane having the position of the center of gravity of the host vehicle M on the two-dimensional plane as the origin of the X direction (vertical direction), for example. The outside recognition unit 102 stores the generated lane data 121 in the storage unit 120. In a case that the lane marker LMm is a white line, the position of the lane marker LMm may be represented as a set of points or a function and the like representing a straight line or a curve line.

For example, the outside recognition unit 102 stores lane data 121 of lane markers LMm corresponding to a predetermined time in the traveling direction of the host vehicle M in the storage unit 120. For example, the predetermined time may be 2 seconds which is several seconds necessary to make an angle θ which will be described later zero in a case that a maximum speed of the host vehicle M at which lane change control operates is 40 [m/s]. Here, the lane markers LMm corresponding to the predetermined distance correspond to 80 [m], for example.

The host vehicle position recognition unit 104 recognizes a lane (traveling lane) in which the host vehicle M is traveling and a relative position and an attitude of the host vehicle M with respect to the traveling lane on the basis of two lane markers LMm closest to the host vehicle M among the lane markers LMm recognized by the outside recognition unit 102, for example.

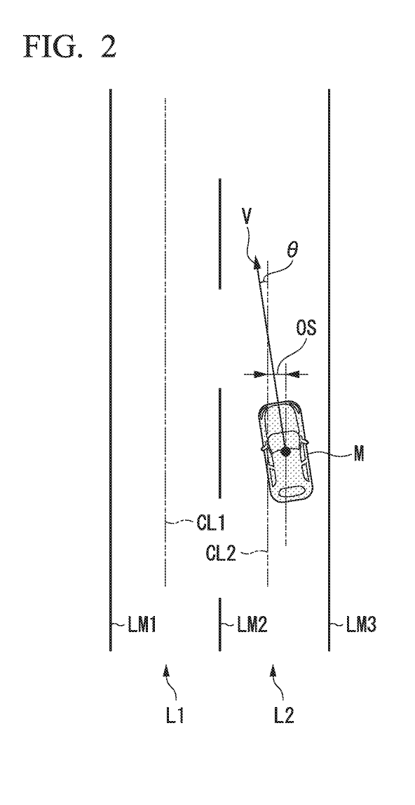

FIG. 2 is a diagram showing a state in which a relative position and an attitude of the host vehicle M with respect to a lane L2 are recognized by the host vehicle position recognition unit 104. For example, the host vehicle position recognition unit 104 recognizes an area between two lane markers LM2 and LM3 closest to the host vehicle M as the lane L2 in which the host vehicle M is traveling on the basis of lane markers LM1 to LM3 recognized by the outside recognition unit 102.

The host vehicle position recognition unit 104 sets a virtual center line between the lane marker LM1 and the lane marker LM2 as a traveling lane center CL1 and sets a virtual center line between the lane marker LM2 and the lane marker LM3 as a traveling lane center CL2. Hereinafter, the traveling lane center CL1 and the traveling lane center CL2 are described as a traveling lane center CL in a case that they are referred to generally. In addition, the host vehicle position recognition unit 104 sets a distance OS by which a reference point (e.g., the center of gravity) of the host vehicle M is distant from the position of the traveling lane center CL and derives a relative position of the host vehicle M in the lane L2 on the basis of the distance OS.

Alternatively, the host vehicle position recognition unit 104 may derive the position of the reference point of the host vehicle M and the like with respect to the lane marker LM1 or the lane marker LM2 as a relative position of the host vehicle M with respect to the traveling lane.

The host vehicle position recognition unit 104 derives an angle θ between a lane marker LMm or the extending direction of the traveling lane center CL and to a yaw angle of the host vehicle M. For example, the host vehicle position recognition unit 104 derives an angle between a reference direction V of the yaw angle and the traveling lane center CL as the angle θ. The reference direction V of the yaw angle may be a direction of a back-and-forth direction axis of the vehicle or a displacement direction of the position of center of gravity at that moment. In addition, the reference direction V may be a direction similar thereto.

For example, the following travel assistance control unit 106 performs control of following a neighboring vehicle which is traveling in front of the host vehicle M in a traveling direction of the host vehicle M and is recognized by the outside recognition unit 102. For example, the following travel assistance control unit 106 starts following travel assistance control by being triggered by execution of an operation (operation for performing following travel assistance control performed by an occupant) on the following travel start switch 52. For example, the following travel assistance control unit 106 controls the traveling driving power output device 200 and the brake device 210 such that the host vehicle M follows a neighboring vehicle (hereinafter referred to as a preceding vehicle) present within a predetermined distance (e.g., approximately 50 [m]) in front of the host vehicle M among neighboring vehicles recognized by the outside recognition unit 102 to control the speed of the host vehicle M. Here, the following travel assistance control unit 106 may set an upper limit and a lower limit for the speed of the host vehicle M.

For example, “following” refers to a traveling state in which a constant relative distance between the host vehicle M and a preceding vehicle (a distance between vehicles) is maintained. In the following description, driving assistance control for assisting traveling of the host vehicle M in such a traveling state is referred to as “following travel assistance control.” The following travel assistance control unit 106 may simply cause the host vehicle M to travel at a set vehicle speed in a case that no preceding vehicle is recognized by the outside recognition unit 102.

The lane keeping assistance control unit 108 controls the steering device 220 such that a lane in which the host vehicle M travels is kept on the basis of the position of the host vehicle M recognized by the host vehicle position recognition unit 104. For example, the lane keeping assistance control unit 108 starts lane keeping assistance control by being triggered by execution of an operation (operation for performing lane keeping assistance control performed by the occupant) on the lane keeping start switch 54 performed by the occupant. For example, the lane keeping assistance control unit 108 controls steering of the host vehicle M such that the host vehicle M travels at the traveling lane center CL.

For example, the lane keeping assistance control unit 108 controls the steering device 220 such that a greater steering force is output in a direction in which the host vehicle M returns to the position of the traveling lane center CL as separation of the reference point of the host vehicle M from the traveling lane center CL increases. In the following description, driving assistance control for controlling the host vehicle such that it travels at the traveling lane center DL is referred to as “lane keeping assistance control.”

Furthermore, the lane keeping assistance control unit 108 may control steering such that the host vehicle M returns to the side of the traveling lane center CL by controlling the steering device 220 to perform lane deviation prevention control in a case that the host vehicle M approaches the lane marker LM2 or the lane marker LM3.

The lane change assistance control unit 110 controls the traveling driving power output device 200, the brake device 210 and the steering device 220 without an operation of the steering wheel (steering control) performed by the occupant such that the host vehicle M changes lanes to a neighboring lane determined to be changeable to. For example, the lane change assistance control unit 110 starts lane change assistance control by being triggered by execution of an operation (operation for performing lane change assistance control by the occupant) on the lane change start switch 56.

Here, control of the lane change assistance control unit 110 is performed in a state in which following travel assistance control performed by the following travel assistance control unit 106 and lane keeping assistance control performed by the lane keeping assistance control unit 108 are activated, for example. In a case that the lane change start switch 56 is operated, for example, control of the lane change assistance control unit 110 is preferentially performed.

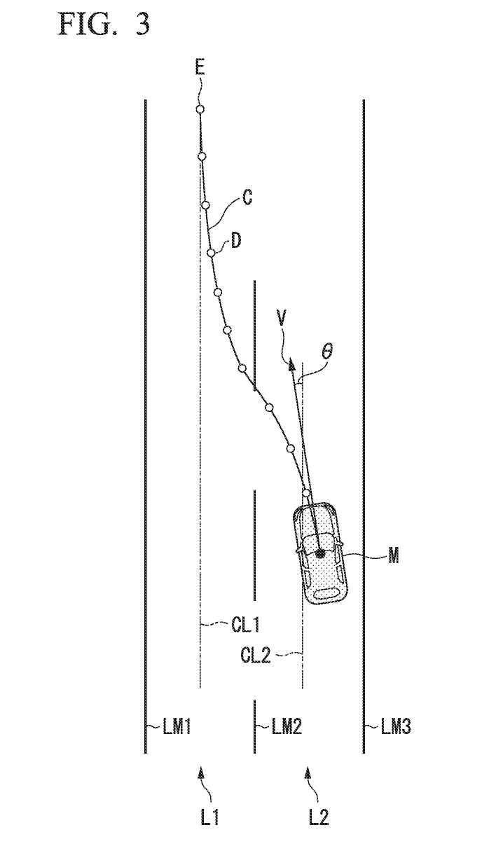

FIG. 3 is a diagram showing contents of a process performed by the lane change assistance control unit 110. The lane change assistance control unit 110 generates a trajectory for lane change of the host vehicle M.

The lane change assistance control unit 110 derives a distance necessary for lane change of the host vehicle M on the basis of the speed of the host vehicle M and the number of seconds necessary for lane change. In a case that a lane change end point E is not recognized within a range captured by the camera 10, for example, the lane change end point E is calculated on the assumption that the lane change end point E extends from a part in which lanes can be recognized at the curvature thereof. For example, in a case that it is preset that information on the front detected by the camera 10 is about ⅓ of the road necessary for lane change, if a range detected by the camera 10 in a case that lane change is started is a straight line of 60 [m], the end point E is calculated as 180 [m] ahead on the assumption that the straight line continues ahead. If a lane detected by the camera 10 is a curve having a radius of curvature of 1000 [m], the end point E is calculated on the assumption that the curve continues at the radius of curvature.

The number of seconds necessary for lane change is set on the basis of a distance until the vehicle has traveled a target distance in the horizontal direction in a case that it is assumed that a distance of horizontal movement in a case that lane change is performed is almost constant and lane change has been performed at an appropriate speed in the horizontal direction. The lane change assistance control unit 110 sets the lane change end point E on the traveling lane center CL1 in a lane L1 which is a lane change destination on the basis of the derived distance necessary for lane change. For example, the lane change assistance control unit 110 performs lane change assistance control having the lane change end point E as a target position.

For example, the lane change assistance control unit 110 generates a trajectory C for lane change by smoothly connecting the current position of the host vehicle M and the lane change end point E using a polynomial curve such as a spline curve on the basis of a reference direction V of the current position and yaw angle of the host vehicle M and a reference direction V of the position and yaw angle of the set lane change end point E. For example, the lane change assistance control unit 110 generates a plurality of trajectory points D on the generated trajectory C at a predetermined interval. For example, the lane change assistance control unit 110 causes the host vehicle M to travel to sequentially pass the generated trajectory points D.

### Lane Change Assistance Control

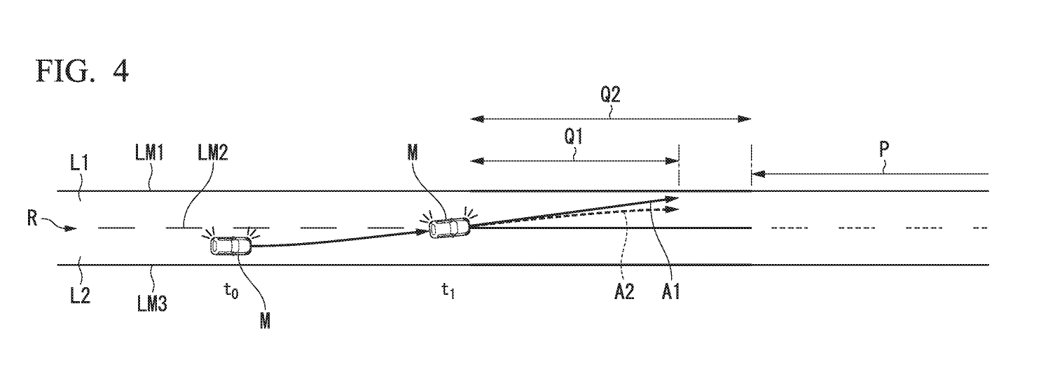

Hereinafter, lane change assistance of the host vehicle M will be described. FIG. 4 is a diagram showing an example of a state in which there is a non-detection section P in which a lane marker LM2 is difficult to see during lane change assistance control. As shown, it is assumed that there is the non-detection section P in which the lane marker LM2 is difficult to see on a road R on which the host vehicle M is traveling. For example, the non-detection section P is generated in cases in which a lane marker LMm cannot be recognized such as a case in which the lane marker LMm is not clear and a case in which there is a preceding vehicle.

Here, in a case that the host vehicle M performs lane change according to lane change assistance control, the lane marker LM2 is not recognized during lane change and thus a correct control target may not be given in lane change assistance control. In a case that lane change assistance control is canceled on the way, the host vehicle M does not suddenly deviate from the lane because a steering angle is restored to zero according to a self-aligning torque (SAT) of the steering device 220. However, the host vehicle M may deviate from a trajectory indicated by an arrow A2 which is a target, as represented by a trajectory indicated by an arrow A1.

Here, the lane change assistance control unit 110 determines whether lane change can be ended on the basis of lane data 121 of a lane marker LMm in a predetermined range stored in the storage unit 120 in a case that the lane marker LMm is not detected by the outside recognition unit 102 during lane change.

Specifically, the lane change assistance control unit 110 starts lane change assistance control from a time t0 and, in a case that the lane marker LMm is not detected at a point corresponding to a time t1, compares a first distance Q1 remaining until lane change will be ended with a second distance Q2 of the lane marker LMm stored in the storage unit 120, for example.

For example, data corresponding to the second distance Q2 of the lane marker LMm at the point in time of the time t1 is stored in the lane data 121. The lane change assistance control unit 110 calculates the first distance Q1 remaining until lane change will be ended. For example, the first distance Q1 is calculated on the basis of a speed at the time t1 and a time remaining until lane change will be ended.

For example, the lane change assistance control unit 110 calculates the second distance Q2 of the lane marker LMm recognized at the time t1 on the basis of the lane data 121. The second distance Q2 is calculated on the basis of data obtained by converting an image of the lane marker LMm in a predetermined range captured by the camera 10 into data represented as relative coordinates with respect to the host vehicle M on the two-dimensional plane.

The lane change assistance control unit 110 calculates a difference between the calculated first distance Q1 and second distance Q2 and, in a case that the second distance Q2 is equal to or longer than the first distance Q1 (Q2≥Q1) and it is determined that the host vehicle M is able to end lane change within the second distance Q2 as a calculation result, controls lane change of the host vehicle M on the basis of a relative distance between the position of the lane marker LMm in the predetermined range stored in the storage unit 120 and the host vehicle M.

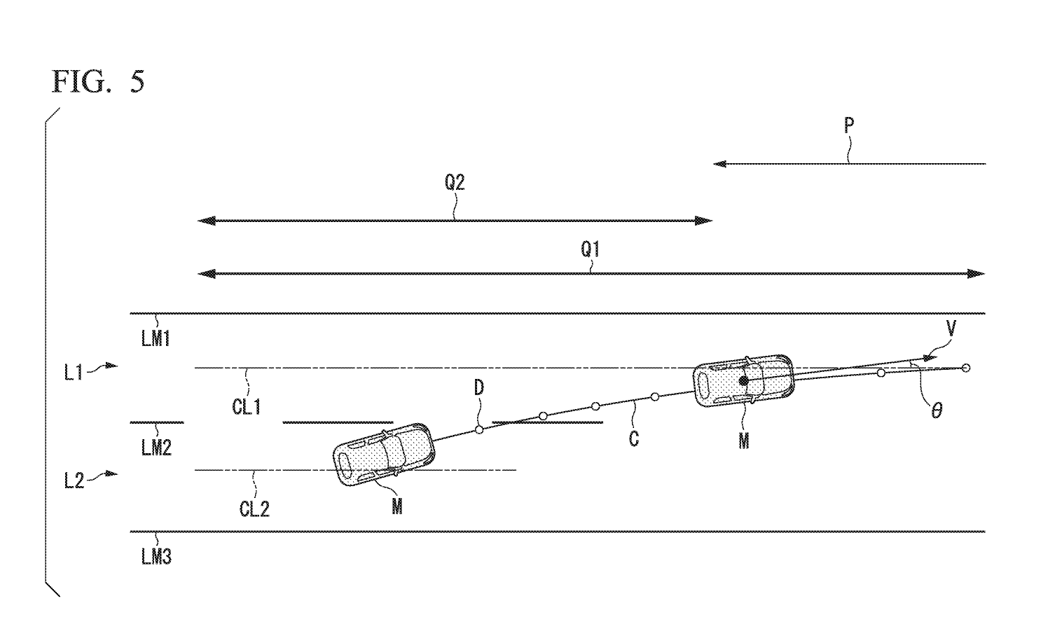

FIG. 5 is a diagram describing an example of lane change assistance control in a case that the second distance Q2 is shorter than the first distance Q1. The lane change assistance control unit 110 calculates a difference between the calculated first distance Q1 and second distance Q2 and, in a case that the second distance Q2 is shorter than the first distance Q1 (Q2<Q1) and it is determined that the host vehicle M is not able to end lane change within the second distance Q2 as a calculation result, causes the host vehicle M to travel in a direction in which an angle θ between the lane marker LMm and the reference direction V of the yaw angle of the host vehicle M decreases. The lane change assistance control unit 110 sets a point at which the angle θ becomes zero as a target position.

For example, the lane change assistance control unit 110 causes the host vehicle M to travel in a direction in which the angle θ to the reference direction V of the yaw angle of the host vehicle M decreases after the time t1 to end lane change. Thereafter, the lane change assistance control unit 110 causes control of the host vehicle M to switch the lane keeping assistance control unit 108, for example. The host vehicle M may travel in any lane close thereto among the lanes L1 and L2 according to control of the lane keeping assistance control unit 108.

### Process Flow

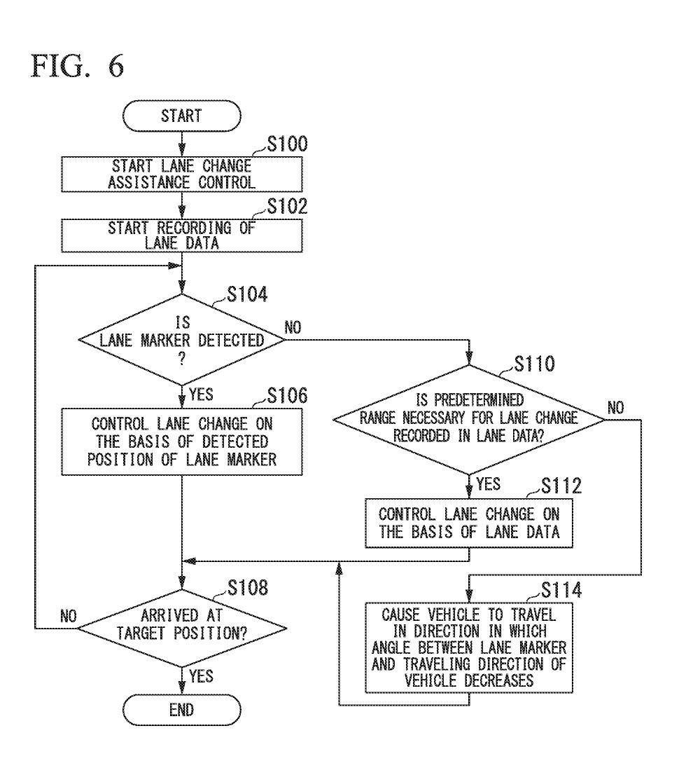

Next, a process flow of the vehicle control system 1 will be described. FIG. 6 is a flowchart showing an example of a process flow of the vehicle control system 1.

The lane change assistance control unit 110 starts lane change assistance control by being triggered by a predetermined operation of an occupant (step S100). Then, the outside recognition unit 102 starts recording of lane markers LMm in a predetermined range (step S102). Subsequently, the lane change assistance control unit 110 determines whether the outside recognition unit 102 has detected a lane marker LMm (step S104).

Thereafter, in a case that the outside recognition unit 102 has detected a lane marker LMm, the lane change assistance control unit 110 controls lane change on the basis of the position of the detected lane marker LMm (step S106). The lane change assistance control unit 110 determines whether the host vehicle M has arrived at a target position (step S108). The lane change assistance control unit 110 ends the process in a case that the host vehicle M has arrived at the target position and returns to the process of step S104 in a case that the host vehicle M has not arrived at the target position.

In a case that negative determination has been performed in step S104, the lane change assistance control unit 110 determines whether lane change can be ended by determining whether data of lane markers in a predetermined range necessary for lane change has been recorded in lane data 121 stored in the storage unit 120 (step S110). In a case that it is determined that lane change can be ended, the lane change assistance control unit 110 controls lane change of the host vehicle M on the basis of the lane data 121 of lane markers LMm in the predetermined range stored in the storage unit 120 (step S112).

Subsequently, the lane change assistance control unit 110 proceeds to the process of step S108. In a case that negative determination has been performed in step S110, the lane change assistance control unit 110 causes the host vehicle M to travel in a direction in which an angle θ between the detected lane marker LMm and the traveling direction of the host vehicle M decreases (step S114). The lane change assistance control unit 110 determines whether the host vehicle M has arrived at the target position (step S108) and ends the process of the flow chart in a case that the host vehicle M has arrived at the target position.

According to the above-described first embodiment, the vehicle control system 1 is able to end lane change with reference to lane markers LMm stored in a predetermined range in the storage unit 120 even in a case that no lane marker LMm is detected in lane change assistance control.

### SECOND EMBODIMENT

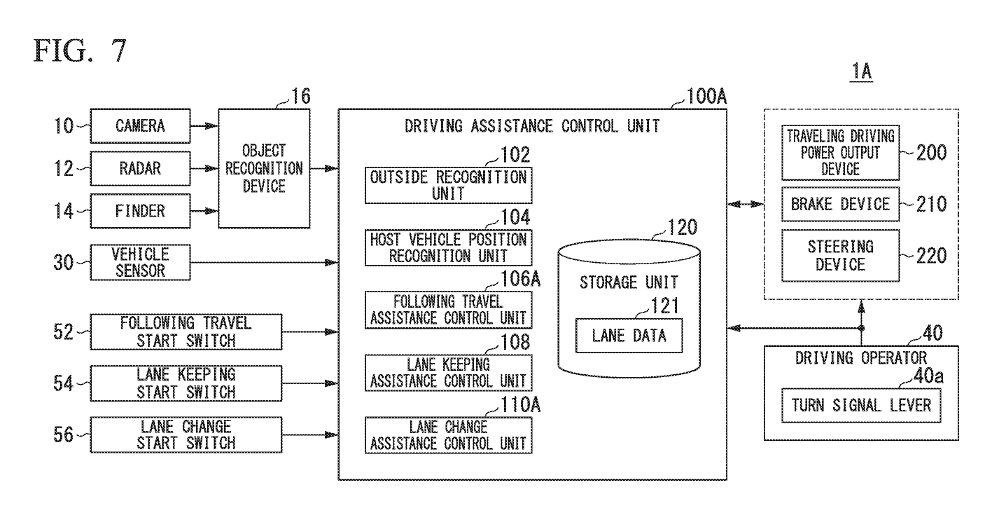

In the vehicle control system 1 of the first embodiment, lane change is ended on the basis of the lane data 121 stored in the storage unit 120 after no lane marker LMm has been detected during lane change assistance control. In a vehicle control system 1A of a second embodiment, the host vehicle M travels following a vehicle traveling in front thereof to end lane change after no lane marker LMm has been detected during lane change assistance control. In the following description, components the same as those in the first embodiment are denoted using the same terms and redundant description will be appropriately omitted. FIG. 7 is a diagram showing an example of a configuration of the vehicle control system 1A of the second embodiment.

### Lane Change Assistance Control

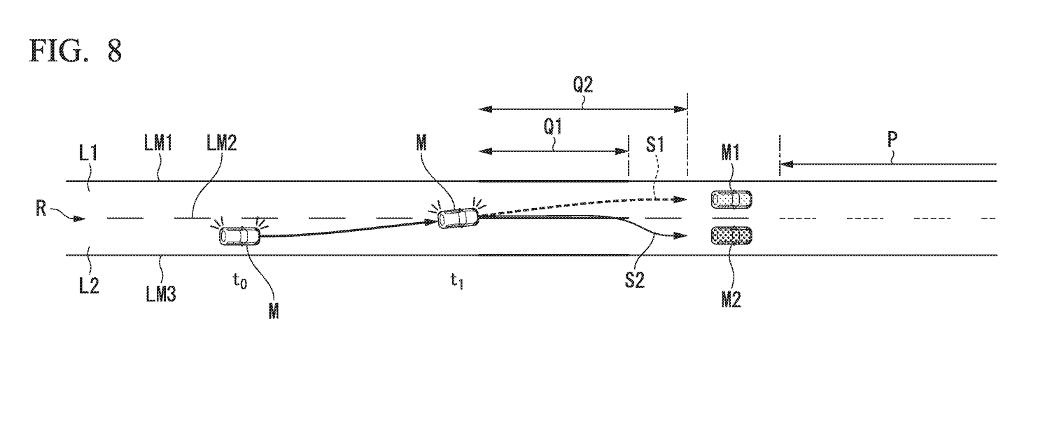

FIG. 8 is a diagram showing an example of a state in which there is a non-detection section P in which a lane marker LM2 is difficult to see during lane change assistance control. As shown, it is assumed that there is the non-detection section P in which the lane marker LM2 is difficult to see on a road R on which the host vehicle M is traveling. Here, it is assumed that another vehicle (a preceding vehicle M1 or a preceding vehicle M2) is traveling in front of the host vehicle M.

For example, a lane change assistance control unit 110A starts lane change assistance control from a time t0 and, in a case that no lane marker LMm has been detected at a point corresponding to a time t1, determines whether lane change can be ended on the basis of lane data 121 of lane markers LMm in a predetermined range stored in the storage unit 120.

For example, the lane change assistance control unit 110A performs the same process as the process of the vehicle control system 1 of the first embodiment in a case that it is determined that lane change can be ended on the basis of image data of lane markers LMm in the predetermined range. The lane change assistance control unit 110A instructs a following travel assistance control unit 106A to perform following travel assistance control for the host vehicle M with respect to the preceding vehicle M1 or the preceding vehicle M2 in a case that it is determined that lane change cannot be ended on the basis of the lane data 121 of the lane markers LMm in the predetermined range.

In a case that the preceding vehicle M1 is traveling in a lane L1 which is a lane change target, the lane change assistance control unit 110A instructs the following travel assistance control unit 106A to perform following travel assistance control for the host vehicle M with respect to the preceding vehicle M1. For example, the following travel assistance control unit 106A causes the host vehicle M to travel following the preceding vehicle M1 along a trajectory S1 on the basis of the instruction. As a result, the host vehicle M is able to perform lane change to the lane L1 which is the lane change target.

The lane change assistance control unit 110A instructs the following travel assistance control unit 106A to perform following travel assistance control for the host vehicle M with respect to the preceding vehicle M2 in a case that the preceding vehicle M1 is not traveling in the lane L1 which is the lane change target and the preceding vehicle M2 is traveling in a lane L2 which is a lane change origin.

For example, the following travel assistance control unit 106A causes the host vehicle M to travel following the preceding vehicle M2 along a trajectory S2 on the basis of the instruction. As a result, the host vehicle M returns to the lane L2 which is the lane change origin and thus can be prevented from deviating from the lane although lane change is stopped.

### Process Flow

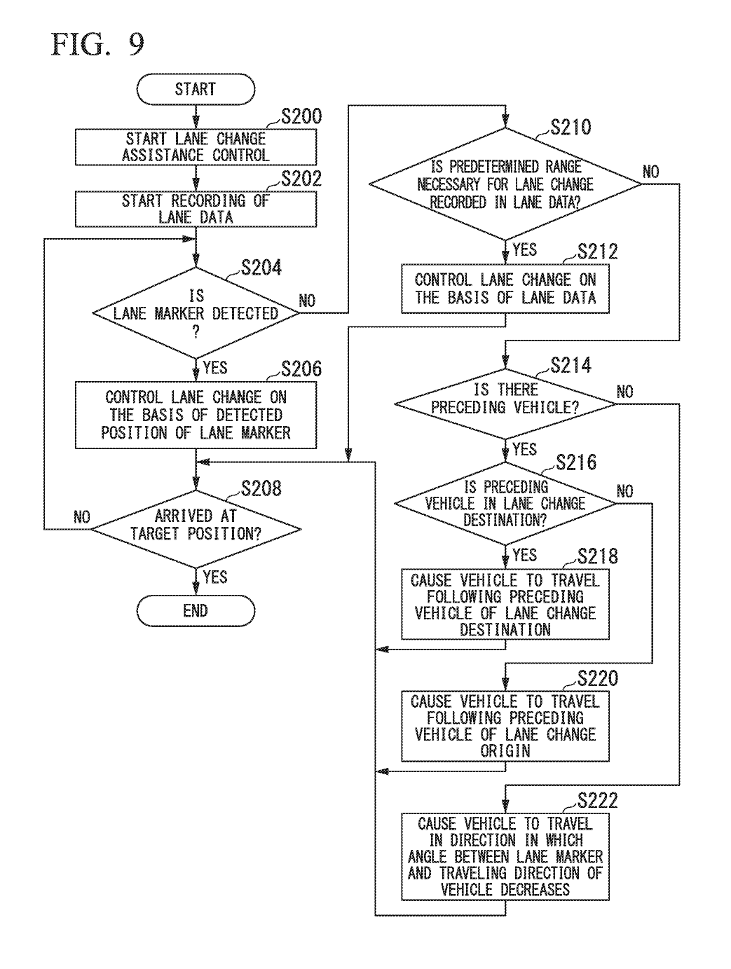

Next, a process follow of the vehicle control system 1A will be described. FIG. 9 is a flowchart showing an example of a process flow of the vehicle control system 1A.

The lane change assistance control unit 110A starts lane change assistance control by being triggered by a predetermined operation of an occupant (step S200). Then, the outside recognition unit 102 starts recording of lane markers LMm in a predetermined range (step S202). Subsequently, the lane change assistance control unit 110 determines whether the outside recognition unit 102 has detected a lane marker LMm (step S204).

Thereafter, in a case that the outside recognition unit 102 has detected a lane marker LMm, the lane change assistance control unit 110A controls lane change on the basis of the position of the detected lane marker LMm (step S206). The lane change assistance control unit 110A determines whether the host vehicle M has arrived at a target position (step S208). The lane change assistance control unit 110A ends the process in a case that the host vehicle M has arrived at the target position and returns to the process of step S204 in a case that the host vehicle M has not arrived at the target position.

In a case that negative determination has been performed in step S204, the lane change assistance control unit 110A determines whether lane change can be ended on the basis of data of lane markers in a predetermined range stored in the storage unit 120 (step S210). In a case that it is determined that lane change can be ended, the lane change assistance control unit 110A controls lane change of the host vehicle M on the basis of the lane data 121 of lane markers LMm in the predetermined range stored in the storage unit 120 (step S212).

Subsequently, the lane change assistance control unit 110A proceeds to the process of step S208. In a case that negative determination has been performed in step S210, the lane change assistance control unit 110A determines whether there is a preceding vehicle on the basis of the recognition result of the outside recognition unit 102 (step S214). In a case that there is a preceding vehicle, the following travel assistance control unit 106A determines whether the preceding vehicle is in a lane which is a lane change destination (step S216). In a case that the preceding vehicle is in the lane which is the lane change destination, the following travel assistance control unit 106A causes the host vehicle M to travel following the preceding vehicle traveling in the lane which is the lane change destination on the basis of an instruction of the lane change assistance control unit 110A (step S218).

In a case that the preceding vehicle is not in the lane which is the lane change destination, the following travel assistance control unit 106A causes the host vehicle M to travel following a preceding vehicle traveling in a lane which is a lane change origin on the basis of an instruction of the lane change assistance control unit 110A (step S220). In a case that negative determination has been performed in step S214, the lane change assistance control unit 110A causes the host vehicle M to travel in a direction in which an angle θ between a detected lane marker LMm and the traveling direction of the host vehicle M decreases (step S222). The lane change assistance control unit 110A determines whether the host vehicle M has arrived at the target position (step S208) and, in a case that the host vehicle M has arrived at the target position, ends the process of the flowchart.

According to the above-described vehicle control system 1A, it is possible to end lane change by causing the host vehicle M to travel following a preceding vehicle even in a case that no lane marker LMm is detected in lane change assistance control.

### Modified Example

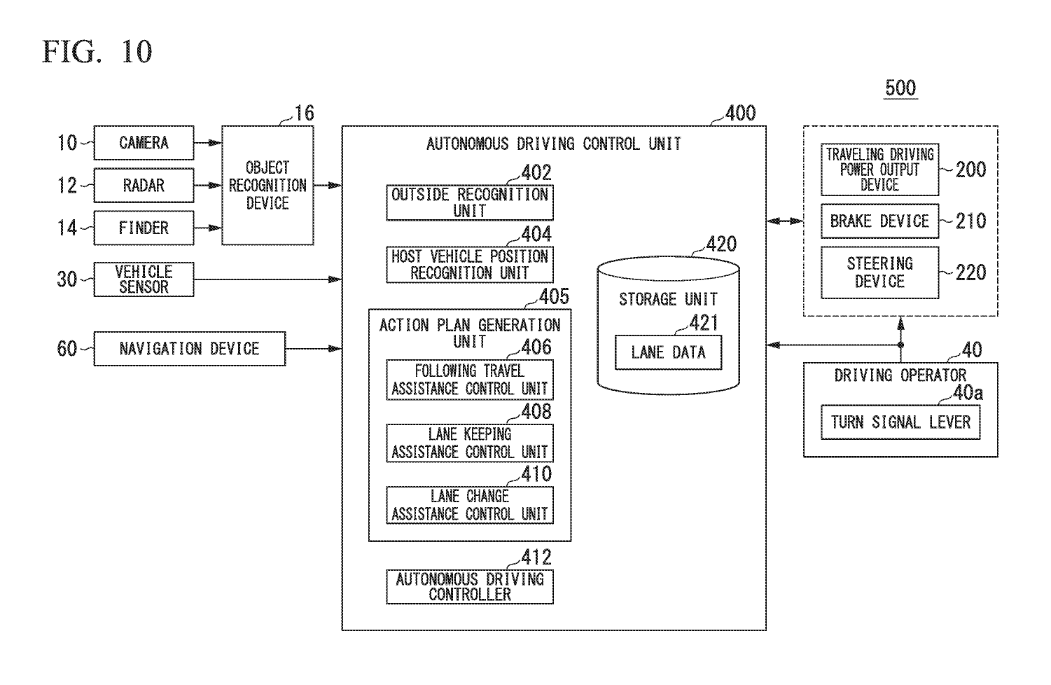

The vehicle control systems of the above-described embodiments may be integrated into an autonomous drive vehicle 500. FIG. 10 is a diagram showing an example of a configuration in which a vehicle control system is applied to the autonomous drive vehicle 500. In the following description, components the same as those described above are denoted using the same terms and redundant description will be appropriately omitted. An autonomous driving control unit 400 in the autonomous drive vehicle 500 is a substitute for the driving assistance control unit 100.

Each component of a following travel assistance control unit 406, a lane keeping assistance control unit 408 and a lane change assistance control unit 410 is integrated into an action plan generation unit 405. The autonomous driving control unit 400 is connected to a navigation device 60. The navigation device 60 outputs a route to a destination to the action plan generation unit 405. The action plan generation unit 405 determines a recommended lane in which the vehicle will travel with reference to a more detailed map than map data included in the navigation device 60 and outputs the recommended lane to an autonomous driving controller 412.

The autonomous driving controller 412 controls some or all of the traveling driving power output device 200 including an engine and a motor, the brake device 210 and the steering device 220 such that the vehicle travels along the recommended lane input from the action plan generation unit 405 on the basis of information recognized by the outside recognition unit 402.

In this autonomous drive vehicle 500, a situation in which lane change is performed automatically according to a traveling situation of the host vehicle M or on the basis of an instruction of an occupant occurs. The autonomous drive vehicle 500 is able to automatically perform lane change according to the process of the driving assistance control unit 100.

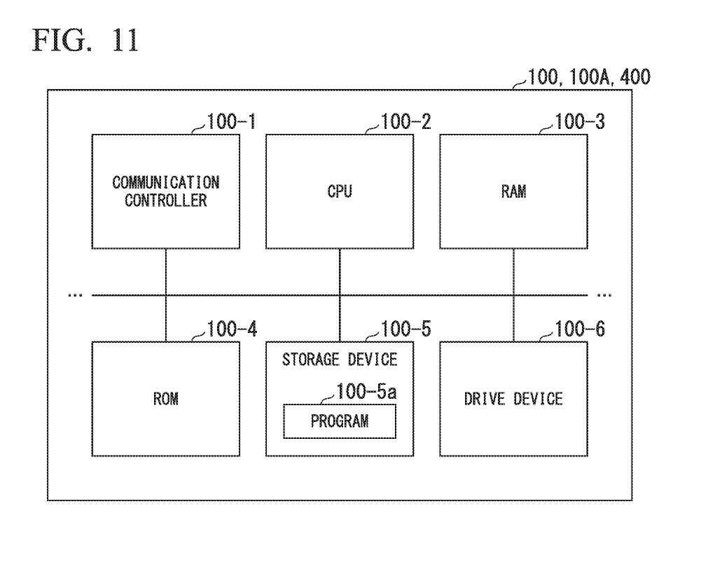

The above-described embodiments may be represented as follows. FIG. 11 is a diagram showing a plurality of configurations which may be used in the driving assistance control units 100 and 100A or the autonomous driving control unit 400. The driving assistance control unit 100 has a configuration in which a communication controller 100-1, a CPU 100-2, a random access memory (RAM) 100-3 used as a working memory, a read only memory (ROM) 100-4 storing a booting program and the like, a storage device 100-5 such as a flash memory and a hard disk drive (HDD), a drive device 100-6 and the like are connected through an internal bus or a dedicated communication line. The communication controller 100-1 performs communication with components other than the driving assistance control unit 100 shown in FIG. 1 and FIG. 7. A program 100-5a executed by the CPU 100-2 is stored in the storage device 100-5. This program is developed in the RAM 100-3 according to a direct memory access (DMA) controller (not shown) or the like and executed by the CPU 100-2. Accordingly, some or all of the host vehicle position recognition unit 104, the following travel assistance control unit 106, the lane keeping assistance control unit 108 and the lane change assistance control unit 110 are realized.

The above-described embodiments may be realized as follows.

A vehicle control system includes a hardware processor and a storage device, wherein the storage device stores a program which causes the hardware processor to perform first control of detecting the position of a lane marker on a road surface in a traveling direction of a vehicle, to store the detected position of the lane marker in a predetermined range in the traveling direction in a storage unit, and to perform second control of controlling lane change of the vehicle on the basis of the detected position of the lane marker, wherein the second control determines whether the lane change is possible on the basis of the position of the lane marker in the predetermined range stored in the storage unit in a case that the lane marker is not detected and controls the lane change of the vehicle on the basis of the position of the lane marker in the predetermined range in a case that it is determined that the lane change is possible.

Although forms for embodying the present invention have been described using embodiments, the present invention is not limited to the embodiments and various modifications and substitutions can be made without departing from the spirit or scope of the present invention. For example, although the lane data 121 stored in the storage unit 120 is used in a case that the lane marker LMm is not recognized in the above-described embodiments, the lane change assistance control unit may perform lane change control on the basis of a highly accurate map and a GPS.

What is claimed is:

1. A vehicle control system comprising:
a detection unit which detects a position of a lane marker on a road surface in a traveling direction of a vehicle;
a storage unit which stores the position of the lane marker detected by the detection unit in a predetermined range in the traveling direction; and
a lane change control unit which controls lane change of the vehicle on the basis of the position of the lane marker detected by the detection unit,
wherein the lane change control unit determines whether lane change is possible on the basis of the position of the lane marker in the predetermined range stored in the storage unit in a case that the position of the lane marker is not detected by the detection unit and controls lane change of the vehicle on the basis of the position of the lane marker in the predetermined range stored in the storage unit in a case that it is determined that lane change is possible.

2. The vehicle control system according to claim 1, wherein the lane change control unit determines whether lane change can be ended on the basis of the position of the lane marker in the predetermined range stored in the storage unit in a case that the position of the lane marker is not detected by the detection unit during a period from start to end of lane change and, in a case that it is determined that lane change cannot be ended, causes the vehicle to travel in a direction in which an angle between an extending direction of the lane marker in the predetermined range stored in the storage unit and a yaw angle of the vehicle decreases.

3. The vehicle control system according to claim 1, wherein the detection unit further detects a position of another vehicle traveling in front of the vehicle, and the lane change control unit determines whether lane change can be ended on the basis of the position of the lane marker in the predetermined range stored in the storage unit in a case that the position of the lane marker is not detected by the detection unit during a period from start to end of lane change and, in a case that it is determined that lane change cannot be ended, causes the vehicle to travel following the other vehicle.

4. The vehicle control system according to claim 3, wherein the lane change control unit determines whether lane change can be ended on the basis of the position of the lane marker in the predetermined range stored in the storage unit in a case that the position of the lane marker is not detected by the detection unit during the period from start to end of lane change and, in a case that it is determined that lane change cannot be ended, causes the vehicle to travel following another vehicle traveling in a lane which is a lane change destination.

5. The vehicle control system according to claim 4, wherein the lane change control unit determines whether lane change can be ended on the basis of the position of the lane marker in the predetermined range stored in the storage unit in a case that the position of the lane marker is not detected by the detection unit during the period from start to end of lane change and, in a case that it is determined that lane change cannot be ended and there are no other vehicles traveling in the lane which is the lane change destination, causes the vehicle to travel following another vehicle traveling in a lane which is a lane change origin.

6. A vehicle control method executed by a computer mounted in a vehicle, wherein the computer:
detects a position of a lane marker on a road surface in a traveling direction of a vehicle;
stores the detected position of the lane marker in a predetermined range in the traveling direction in a storage unit;
controls lane change of the vehicle on the basis of the detected position of the lane marker;
determines whether lane change is possible on the basis of the position of the lane marker in the predetermined range stored in the storage unit in a case that the lane marker is not detected; and
controls lane change of the vehicle on the basis of the position of the lane marker in the predetermined range in a case that it is determined that lane change is possible.

7. A computer readable non-transitory storage medium storing a program which causes a computer:
to detect a position of a lane marker on a road surface in a traveling direction of a vehicle,
to store the detected position of the lane marker in a predetermined range in the traveling direction in a storage unit,
to control lane change of the vehicle on the basis of the detected position of the lane marker and determine whether lane change is possible on the basis of the position of the lane marker in the predetermined range stored in the storage unit in a case that the lane marker is not detected, and
to control lane change of the vehicle on the basis of the position of the lane marker in the predetermined range in a case that it is determined that lane change is possible.
